(19) United States
(12) Patent Application Publication
(10) Pub. No.: US 2026/0252922 A1
(43) Pub. Date: Aug. 27, 2026

(54) Memory-Centric Intelligent System Architecture with Admissibility-Governed Structural Participation

(71) Applicant: Xinxin Shan, Surrey (CA)

(72) Inventor: Xinxin Shan, Surrey (CA)

(73) Assignee: LED Smart Inc, Surrey, BC (CA)

(21) Appl. No.: 19/651,249

(22) Filed: Apr. 17, 2026

(51) Int. Cl. G06N 5/04

(52) U.S. Cl. CPC G06N 5/04

(57) ABSTRACT

A memory-centric intelligent system architecture is disclosed in which system behavior is defined as admissibility-governed structural participation of informational structures within a system memory domain. Informational structures are maintained as continuity-preserved memory entities representing system state. Candidate outcomes correspond to non-executable structural proposals, and admissibility corresponds to intrinsic structural conditions of participation rather than evaluation or decision mechanisms. Operational interaction with external environments corresponds to structural participation rather than control logic or execution mechanisms. System experience is maintained as continuity-preserved informational structures, and evolution corresponds to lineage-preserving structural modification of memory entities rather than optimization or algorithmic adaptation.

### CROSS-REFERENCE TO RELATED APPLICATIONS

This application relates to intelligent system architectures and distributed system implementations that are defined according to memory-centric structural principles rather than operational execution models.

### PRIOR ART

The references listed below are provided in accordance with disclosure requirements and are not intended to represent an exhaustive survey of all prior art.

The inclusion of any reference herein does not constitute an admission that such reference is material to patentability, relevant to the claimed invention, or applicable as prior art against the present disclosure.

The cited references represent general technical fields, systems, or approaches that may relate to aspects of distributed systems, communication systems, artificial intelligence, and control architectures, but do not define or limit the structural participation architecture described in the present disclosure.

### US PATENT DOCUMENTS

U.S. Pat. No. 5,958,010 A September 1999 Agarwal et al.

U.S. Pat. No. 6,714,976 B1 March 2004 Wilson et al.

U.S. Pat. No. 6,847,970 B2 January 2005 Keller et al.

U.S. Pat. No. 7,181,519 B2 February 2007 Pillai et al.

U.S. Pat. No. 8,327,442 B2 December 2012 Herz et al.

U.S. Pat. No. 8,577,928 B2 November 2013 Taitel

U.S. Pat. No. 8,655,375 B2 February 2014 Aceves et al.

U.S. Pat. No. 8,832,665 B2 September 2014 Greifeneder et al.

U.S. Pat. No. 9,455,887 B1 September 2016 Upadhyay et al.

U.S. Pat. No. 9,503,470 B2 November 2016 Gertner et al.

U.S. Pat. No. 9,747,162 B2 August 2017 Dayan et al.

U.S. Pat. No. 9,753,796 B2 September 2017 Mahaffey et al.

U.S. Pat. No. 9,866,637 B2 January 2018 Doraiswamy et al.

U.S. Pat. No. 10,007,513 B2 June 2018 Malladi et al

### FOREIGN PATENT DOCUMENTS

EP 1,316,026 A2 June 2003 Uchiyama

WO 2015/153045 A1 November 2015 Shvachko et al.

EP 2,996,901 A1 January 2017 Becker et al.

WO 2024/020133 A1 January 2024 Hirsa et al.

### OTHER PUBLICATIONS

Lamport, Leslie. “Time, Clocks, and the Ordering of Events in a Distributed System Communications of the ACM”, Vol. 21, No. 7, pp. 558-565, July 1978 Goodfellow, Ian et al. “Deep Learning”, MIT Press, 2016
IEEE, “IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications”, (IEEE 802.11-2020), IEEE Standards Association, 2020
Postel, Jon. “Internet Protocol (RFC 791)”, Internet Engineering Task Force (IETF), September 1981
Deering, Steve et al. “Internet Protocol, Version 6 (IPv6) Specification (RFC 8200)”, IETF, July 2017
Shelby, Zach et al. “The Constrained Application Protocol (CoAP) (RFC 7252)”, IETF, June 2014 Amazon Web Services (AWS). “Overview of Amazon Web Services”, AWS Whitepaper

### BACKGROUND OF THE INVENTION

Conventional intelligent systems are typically described in terms of processing pipelines, control logic, or algorithmic execution structures. Such systems are generally characterized by sequential operations, decision-making processes, and transformation of input data into output actions.

These approaches are commonly associated with execution-oriented system definitions in which system behavior is interpreted as a result of operations, computed decisions, or executed control sequences.

In such systems, memory is typically treated as a passive storage component used for retrieval or buffering, and system behavior is derived from processing mechanisms external to memory.

In contrast, the present disclosure is defined in terms of structural participation relationships within a system memory domain rather than operations, computed decisions, or control logic.

Accordingly, there exists a need for an alternative system architecture in which system behavior corresponds to structural admissibility relationships rather than execution-based processing or algorithmic inference mechanisms.

### SUMMARY OF THE INVENTION

The present disclosure describes a memory-centric intelligent system architecture in which informational structures exist as continuity-preserved memory entities within a system memory domain.

In this architecture, informational structures correspond to observations, system states, contextual conditions, operational outcomes, and accumulated system experience. Candidate outcomes correspond to non-executable structural proposals derived from informational structures.

Admissibility corresponds to intrinsic structural conditions of participation rather than evaluation, selection, or decision determination mechanisms.

Operational interaction with external environments corresponds to admissibility-governed structural participation rather than control commands, triggering mechanisms, or control logic.

System experience is maintained as continuity-preserved informational structures, and system evolution corresponds to lineage-preserving structural modification of memory entities rather than optimization, training, or adaptive control processes.

Accordingly, system behavior is defined as structural participation relationships within system memory rather than execution sequences, control flows, or algorithmic processes.

### BRIEF DESCRIPTION OF DRAWINGS

FIG. 1—Overall Constitutional System Structure

FIG. 2—Informational Structuring and Qualification Structure

FIG. 3—System Memory Structure

FIG. 4—Reasoning and Candidate Constitution Structure

FIG. 5—Admissibility and Governance Structure

FIG. 6—Operational Interaction Structure

FIG. 7—Experience Accumulation Structure

FIG. 8—Evolution Structure

### DETAILED DESCRIPTION OF THE INVENTION

The following figures define constitutional structural relationships of a memory-centric intelligent system architecture in which admissibility corresponds to intrinsic structural conditions of participation within a system memory domain. The figures express containment, structural participation, admissibility conditioning, and domain relationships without implying execution sequence, control flow, algorithmic processing, or decision-making mechanisms.

All elements identified by reference numerals constitute inseparable components of a unified system architecture and define structural existence and participation relationships. No element independently defines system behavior. System behavior is constituted exclusively through admissibility-governed structural participation of informational structures and memory entities within system memory.

All structural relationships described herein are defined as existence relationships within a system memory domain and do not constitute operational processes, executable sequences, procedural transformations, or control-enabling mechanisms.

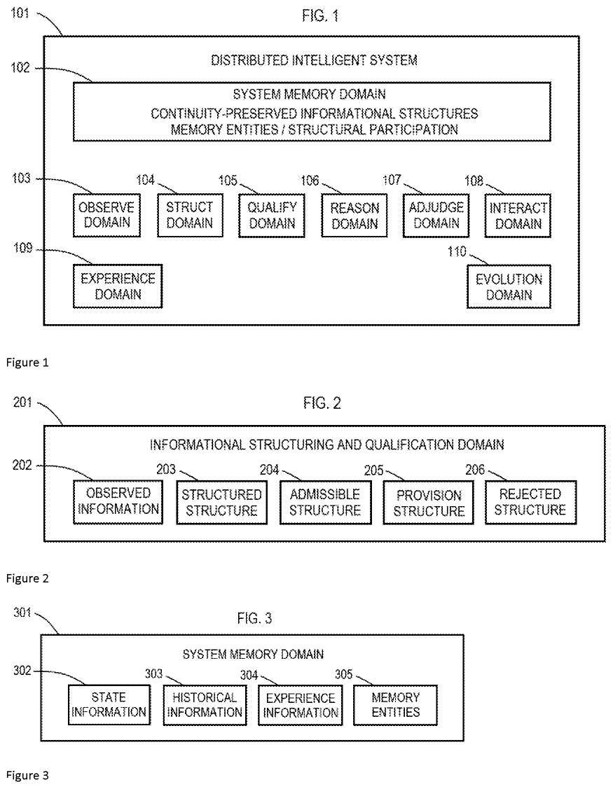

### FIG. 1—OVERALL CONSTITUTIONAL SYSTEM STRUCTURE

A distributed intelligent system (101) defines a unified structural domain within which system memory (102), an observation domain (103), an informational structuring domain (104), an informational qualification domain (105), a reasoning domain (106), an adjudication domain (107), an operational interaction domain (108), an experience accumulation domain (109), and an evolution domain (110) are structurally contained.

The system memory (102) defines a primary structural participation domain within which all other domains exist and correspond, wherein informational structures are maintained as continuity-preserved memory entities.

All domains (103-110) are constituted as structural existence domains within the system memory (102) and do not correspond to operational modules, execution stages, or sequential processing layers.

The observation domain (103) corresponds to reception of informational inputs and formation of observational informational structures. The informational structuring domain (104) corresponds to structural formation of structured informational representations. The informational qualification domain (105) corresponds to classification of informational structures into admissible, provisional, or rejected structures.

The reasoning domain (106) corresponds to constitution of candidate outcomes derived from informational structures within system memory. The adjudication domain (107) corresponds to establishment of admissibility conditions based on contextual conditions, operational constraints, informational consistency, and system objectives.

The operational interaction domain (108) corresponds to structural interaction with external environments and does not represent execution logic, control behavior, or command issuance.

The experience accumulation domain (109) corresponds to structural recording of operational outcomes and contextual conditions. The evolution domain (110) corresponds to structural modification of informational structures based on accumulated system experience.

### FIG. 2—INFORMATIONAL STRUCTURING AND QUALIFICATION STRUCTURE

An informational structuring and qualification domain (201) defines a structural domain containing observational information (202), structured informational representations (203), admissible informational structures (204), provisional informational structures (205), and rejected informational structures (206).

Observational information (202) corresponds to informational inputs received by the system. Structured informational representations (203) correspond to structural formation of informational structures within the system.

Admissible informational structures (204) correspond to informational structures permitted for participation within system memory and other structural domains. Provisional informational structures (205) correspond to conditional participation domains. Rejected informational structures (206) correspond to informational structures excluded from structural participation.

The relationships among (202-206) define admissibility boundaries as intrinsic structural conditions and do not correspond to filtering operations, evaluation procedures, classification algorithms, or decision mechanisms.

### FIG. 3—SYSTEM MEMORY STRUCTURE

A system memory (301) defines a structural domain containing state information (302), historical information (303), experience information (304), and memory entities (305).

State information (302) corresponds to informational representations of current system conditions. Historical information (303) corresponds to informational representations of prior system states. Experience information (304) corresponds to informational representations of recorded operational outcomes and contextual conditions.

Memory entities (305) correspond to structured informational units maintained within system memory.

The system memory (301) constitutes a structural existence and participation domain rather than a storage, retrieval, or processing mechanism, and informational structures are maintained as continuity-preserved entities independent of execution or computational transformation.

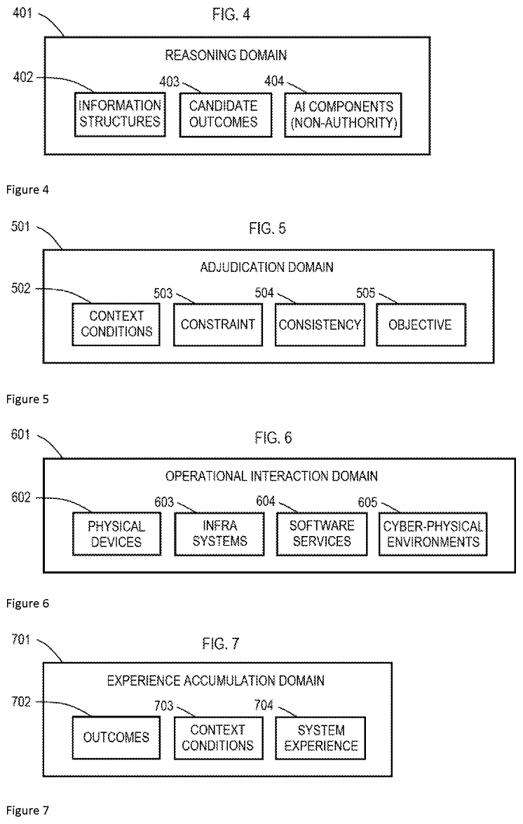

### FIG. 4—REASONING AND CANDIDATE CONSTITUTION STRUCTURE

A reasoning domain (401) defines a structural domain containing informational structures (402), candidate outcomes (403), and artificial intelligence components (404).

Informational structures (402) correspond to informational inputs derived from system memory. Candidate outcomes (403) correspond to structural proposals derived from relationships among informational structures.

Artificial intelligence components (404) correspond to candidate constitution elements.

Artificial intelligence components (404) are restricted to candidate constitution and do not define execution authority, control behavior, or decision-making mechanisms. Candidate outcomes (403) correspond to non-executable structural proposals.

Candidate outcomes (403) exist exclusively as admissibility-dependent structural constructs and do not constitute executable actions, control instructions, or system-triggering mechanisms.

### FIG. 5—ADMISSIBILITY AND GOVERNANCE STRUCTURE

An adjudication domain (501) defines a structural domain containing contextual conditions (502), operational constraints (503), informational consistency (504), and system objectives (505).

Contextual conditions (502), operational constraints (503), informational consistency (504), and system objectives (505) correspond to structural conditions forming admissibility relationships.

The adjudication domain (501) defines admissibility as intrinsic structural conditions of participation and does not correspond to decision determination, rule execution, policy enforcement, or algorithmic evaluation.

Admissibility defines whether candidate outcomes may structurally participate within system domains.

Admissibility is defined as a structural existence boundary rather than a selection mechanism, authorization process, or decision outcome.

### FIG. 6—OPERATIONAL INTERACTION STRUCTURE

An operational interaction domain (601) defines a structural domain containing physical devices (602), infrastructure systems (603), software services (604), and cyber-physical environments (605).

Physical devices (602), infrastructure systems (603), software services (604), and cyber-physical environments (605) correspond to external interaction environments.

The operational interaction domain (601) defines structural interaction governed by admissibility conditions and does not correspond to execution pipelines, control logic, command issuance, or direct triggering.

Interaction occurs only through admissible structural participation.

External interaction is constituted as structural correspondence and does not define actuation sequences, control signals, or command execution pathways.

### FIG. 7—EXPERIENCE ACCUMULATION STRUCTURE

An experience accumulation domain (701) defines a structural domain containing operational outcomes (702), contextual conditions (703), and system experience (704).

Operational outcomes (702) correspond to results of structural interaction. Contextual conditions (703) correspond to conditions associated with such outcomes. System experience (704) corresponds to structural associations of outcomes and contextual conditions.

System experience is maintained as continuity-preserved informational structures within system memory and does not correspond to transient logging or event storage.

System experience constitutes a persistent structural domain of memory entities and does not correspond to logging processes, event streams, or data recording operations.

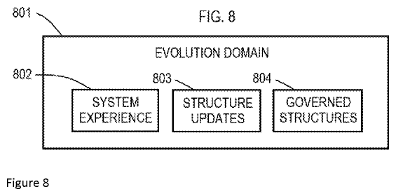

### FIG. 8—EVOLUTION STRUCTURE

An evolution domain (801) defines a structural domain containing system experience (802), informational structure updates (803), and governed structures (804).

System experience (802) corresponds to accumulated informational structures. Informational structure updates (803) correspond to structural modification of informational structures within system memory.

Governed structures (804) correspond to relationships among memory entities that guide system behavior.

Evolution corresponds to lineage-preserving structural modification of informational structures and does not correspond to iterative training, parameter optimization, or adaptive control mechanisms.

Evolution is constituted as structural transformation of memory entities within admissibility constraints and does not correspond to optimization processes, learning algorithms, or model adaptation procedures.

The structures described herein define a memory-centric intelligent system architecture in which system behavior corresponds to structural participation relationships within a unified system memory domain. The described architecture does not impose execution sequence, temporal progression, routing operations, protocol selection, or algorithmic processing. All expressions of system behavior exist as structural admissibility relationships among system elements.

All system elements, including system memory, informational structures, informational structuring domains, informational qualification domains, reasoning domains, adjudication domains, operational interaction domains, experience accumulation domains, and evolution domains, exist as inseparable components within a unified system domain. No processing unit, communication bearer, artificial intelligence component, or external system independently defines system behavior.

Artificial intelligence components, where present, correspond to candidate constitution structures and do not define execution authority, control behavior, or decision-making processes. Admissibility corresponds to intrinsic structural conditions of participation and does not correspond to selection, authorization, decision determination, or rule execution.

In one architectural interpretation, a system comprises at least one processing unit, at least one system memory, informational structuring domains, informational qualification domains, reasoning domains, adjudication domains, operational interaction domains, experience accumulation domains, and evolution domains.

The system memory constitutes a structural participation domain in which informational structures exist as continuity-preserved memory entities. Informational structures correspond to observations, system states, contextual conditions, operational outcomes, and accumulated experience.

The informational structuring domain corresponds to structural normalization of informational representations and does not correspond to transformation operations. The informational qualification domain corresponds to classification as structural admissibility conditions and does not correspond to evaluation, filtering, or decision processes.

The reasoning domain corresponds to constitution of candidate outcomes as non-executable structural proposals. Artificial intelligence components correspond to auxiliary structures for candidate constitution and do not define execution authority or decision-making mechanisms.

The adjudication domain corresponds to admissibility alignment among contextual conditions, operational constraints, informational consistency, and system objectives. Admissibility defines structural participation conditions and does not correspond to evaluation, selection, or decision determination.

The operational interaction domain corresponds to structural interaction with external environments based on admissibility conditions and does not correspond to command execution, control signaling, or triggering mechanisms.

The experience accumulation domain corresponds to structural association of operational outcomes and contextual conditions as continuity-preserved informational structures.

The evolution domain corresponds to lineage-preserving structural modification of informational structures and does not correspond to iterative optimization, training, or adaptive control mechanisms.

### EXAMPLE 1—DISTRIBUTED SENSOR NETWORK

In one example, informational structures correspond to sensor observations distributed across a network of devices.

Sensor observations correspond to structural inclusion within the system memory domain as informational structures. Structured informational representations correspond to structural normalization of observational information.

Candidate outcomes correspond to non-executable structural proposals derived from informational structures. Admissibility alignment corresponds to intrinsic structural participation conditions.

Interaction with devices corresponds to admissibility-governed structural interaction. Operational outcomes and contextual conditions correspond to continuity-preserved structural associations within system memory.

### EXAMPLE 2—AUTONOMOUS SYSTEM COORDINATION

In one example, informational structures correspond to system state representations across distributed autonomous entities.

System states correspond to informational structures within system memory as continuity-preserved entities. Candidate coordination outcomes correspond to non-executable structural proposals.

Admissibility alignment among system states, constraints, and objectives corresponds to intrinsic structural conditions. Interaction among entities corresponds to admissibility-governed structural participation.

Accumulated coordination outcomes correspond to continuity-preserved informational structures within system memory.

### EXAMPLE 3—CYBER-PHYSICAL INFRASTRUCTURE SYSTEM

In one example, informational structures correspond to infrastructure states, environmental conditions, and system responses.

Infrastructure states correspond to informational structures within system memory. Candidate system responses correspond to non-executable structural proposals.

Admissibility alignment across infrastructure conditions, constraints, and objectives corresponds to intrinsic structural participation conditions.

Interaction with infrastructure components corresponds to admissibility-governed structural interaction. System evolution corresponds to lineage-preserving structural modification of informational structures.

1. An apparatus configured according to a memory-centric intelligent system architecture with admissibility-governed structural participation, the apparatus comprising:
at least one processing unit;
at least one system memory configured to store informational structures representing observations, system states, operational outcomes, and accumulated system experience;
an observation component configured to correspond to a structural domain for receiving informational inputs and forming informational structures as structural representations within a system memory domain without constituting execution authority or control behavior;
an informational structuring component configured to correspond to a structural formation domain in which observational informational structures are constituted as structured informational representations, wherein the formation corresponds to structural normalization rather than procedural transformation;
an informational qualification component configured to correspond to a structural classification domain establishing informational status classifications, wherein the classifications define admissibility of structural participation rather than evaluation outputs of algorithmic processing;
a reasoning component configured to correspond to a structural domain in which candidate outcomes are constituted from informational structures within the system memory, wherein the candidate outcomes correspond to non-executable structural proposals;
an adjudication component configured to correspond to a governance structure establishing admissibility conditions based on contextual conditions, operational constraints, informational consistency, and system objectives, wherein admissibility corresponds to intrinsic structural conditions of participation rather than decision determination, selection, authorization, or rule execution;
a structural interaction component corresponding to a structural interaction domain with external environments, wherein such interaction is constituted exclusively through candidate outcomes corresponding to the admissibility conditions and does not correspond to direct triggering, control logic, or command execution;
an experience accumulation component configured to correspond to a structural recording domain in which operational outcomes and contextual conditions are maintained as continuity-preserved informational structures;
an evolution component configured to correspond to a structural modification domain in which informational structures are updated through lineage-preserving relationships derived from accumulated system experience without iterative computational optimization;
wherein the system operates according to a structured intelligence architecture in which system behavior is constituted through admissibility-governed structural participation of informational structures and memory entities within the system memory rather than through sequential processing, rule execution, or algorithmic inference;
wherein the system memory constitutes an operational participation domain rather than a passive storage domain and provides continuity-preserved informational structures for participation across reasoning, adjudication, and evolution; and
wherein informational structures admitted through adjudication are stored as memory entities representing units of system state, and relationships among such memory entities form governed structures that correspond to lineage-preserving structural conditions guiding system behavior without defining executable procedures, control sequences, or operational workflows.

2. The system of claim 1, wherein informational structures include sensor observations, environmental measurements, device states, operational events, analytical results, or external system information, each corresponding to admissible structural participation units.

3. The system of claim 1, wherein the informational qualification component defines admissible, provisional, or rejected informational structures, wherein the classifications define structural participation boundaries rather than filtering operations.

4. The system of claim 1, wherein the reasoning component generates candidate outcomes including structural configurations, system interpretations, or participation constructs, wherein such outcomes correspond to non-executable structural proposals.

5. The system of claim 1, wherein the adjudication component corresponds to admissibility alignment of candidate outcomes using contextual conditions, operational constraints, informational consistency, or system objectives, wherein such alignment corresponds to intrinsic structural admissibility conditions within system structure and not algorithmic decision-making or policy enforcement.

6. The system of claim 1, wherein the structural interaction component interacts with devices, infrastructures, or software systems, wherein such interaction is structurally governed by admissibility conditions and does not correspond to direct control or command issuance.

7. The system of claim 1, wherein operational outcomes are recorded with contextual conditions, forming continuity-preserved informational structures within system memory.

8. A method corresponding to a distributed intelligent system according to a memory-centric intelligence architecture, the method comprising defining a system memory domain, and comprising:
defining reception of informational structures as structural inclusion within said system memory domain;
defining formation of structured informational representations as structural normalization within said system memory domain;
defining informational status classifications as structural admissibility conditions governing participation;
defining storage of informational structures as continuity-preserved existence within said system memory domain;
defining candidate outcomes as non-executable structural proposals derived from informational structures;
defining admissibility alignment of candidate outcomes relative to contextual conditions, operational constraints, informational consistency, or system objectives as intrinsic structural correspondence within system structure;
defining structural interaction with external environments as admissibility-governed participation;
defining recording of operational outcomes with contextual conditions as continuity-preserved structural association;
defining updating of informational structures based on accumulated system experience as lineage-preserving structural modification;
wherein each defined structural relation corresponds to structural participation relationships within said system memory domain and does not constitute a sequence of executable steps, control flow operations, algorithmic procedures, or process execution logic.

9. The method of claim 8, wherein informational structures originate from sensors, computational analyses, artificial intelligence outputs, human inputs, or external system information, each corresponding to admissible participation candidates within the system memory domain.

10. The method of claim 8, wherein establishing informational status classifications includes identifying admissible informational structures, provisional informational structures, or rejected informational structures, wherein such identification corresponds to structural admissibility rather than data filtering operations.

11. The method of claim 8, wherein constituting candidate outcomes includes producing potential structural participation constructs or system state interpretations, wherein such outcomes correspond to non-executable structural proposals.

12. The method of claim 8, wherein admissibility alignment of candidate outcomes includes structural correspondence among contextual conditions, operational constraints, informational consistency, or system objectives, wherein such correspondence defines admissibility conditions within system structure.

13. The method of claim 8, wherein performing structural interaction with devices, infrastructures, or software systems is admissibility-governed rather than control-driven.

14. The method of claim 8, wherein recorded operational outcomes form continuity-preserved informational structures within system memory.

15. A non-transitory computer-readable medium storing instructions that, when executed by at least one processing unit, instantiate a structural participation framework within a system memory domain, the framework being configured to:
define reception of informational structures as structural inclusion within said system memory domain;
define formation of structured informational representations as structural normalization;
define informational status classifications as admissibility conditions governing participation;
define storage as continuity-preserved existence of informational structures;
define candidate outcomes as non-executable structural proposals;
define admissibility alignment of candidate outcomes relative to contextual conditions, operational constraints, informational consistency, or system objectives;
define structural interaction with external environments as admissibility-governed participation;
define recording of operational outcomes with contextual conditions as continuity-preserved structural association; and
define updating of informational structures based on accumulated system experience as lineage-preserving structural modification;
wherein the instructions do not define executable control logic, decision-making authority, algorithmic sequencing, or process execution mechanisms, and correspond exclusively to structural participation relationships within system memory.

16. The computer-readable medium of claim 15, wherein accumulated system experience includes operational events, environmental conditions, system responses, and operational outcomes, each corresponding to continuity-preserved memory entities within system memory.

17. The computer-readable medium of claim 15, wherein updating informational structures produces refined structural relationships among memory entities, wherein such refinement corresponds to lineage-preserving structural modification rather than parameter optimization.

18. The computer-readable medium of claim 15, wherein system evolution updates structural relationships among memory entities based on accumulated operational experience, wherein such updates correspond to governed structural evolution of memory entities.

19. The computer-readable medium of claim 15, wherein the distributed intelligent system operates across multiple nodes connected through communication networks, wherein structural consistency is maintained through admissibility-governed participation of distributed memory entities.

20. The computer-readable medium of claim 15, wherein updated informational structures are propagated across distributed intelligent system nodes, wherein such propagation corresponds to structural consistency maintenance rather than synchronization of execution state.
